(19) United States
(12) Patent Application Publication
(10) Pub. No.: US 2026/0275686 A1
(43) Pub. Date: Sep. 17, 2026

(54) LAMINATED WEAR COMPONENT ADAPTER FOR MATERIAL HANDLING IMPLEMENT

(71) Applicant: BLACK CAT WEAR PARTS, LTD., Edmonton (CA)

(72) Inventor: John A. RUVANG, Bartonville, TX (US)

(21) Appl. No.: 19/079,209

(22) Filed: Mar. 13, 2025

(51) Int. Cl. E02F 9/28; B32B 7/08; B32B 15/01

(52) U.S. Cl. CPC E02F 9/2825; B32B 7/08; B32B 15/011; E02F 9/2833

(57) ABSTRACT

An adapter for connecting a wear component to a lip of a material handling implement can include a connector to releasably secure the wear component to the adapter, legs extending rearward relative to the connector and configured to straddle the lip, and at least one of the connector and the legs comprising multiple separate layers. In another adapter, at least one of the legs is rotatable relative to the connector. A method of mounting an adapter on a lip of a material handling implement can include connecting together multiple separate layers of the adapter. Another method can include rotating at least one of the legs relative to the connector.

### BACKGROUND

This disclosure relates generally to earth-handling, mining and other types of material handling equipment and, in an example described below, more particularly provides a laminated wear component adapter.

Material handling implements (such as buckets, shovels and other types of excavation and mining implements) are frequently provided with replaceable wear components. For example, wear components can be used to protect a forward material-engaging lip of a material handling implement, in order to prevent or delay repair or replacement of the lip, and to achieve other purposes (such as, to enhance the effectiveness of the implement in engaging or breaking up the material).

An adapter can be used to mount a wear component to the lip. The adapter must resist large forces in a variety of different directions applied to the wear component. As a result, structural failures of adapters are undesirably frequent.

It will, therefore, be appreciated that improvements are continually needed in the art of designing, constructing and using adapters for material handling implements. Such improvements are provided to the art by the present disclosure, and these improvements can be realized in a wide variety of different configurations.

### BRIEF DESCRIPTION OF THE DRAWINGS

FIG. 1 is a representative partially cross-sectional view of an example of a material handling implement which can embody principles of this disclosure.

FIG. 2 is a representative exploded perspective view of an example of an adapter that may be used with the FIG. 1 material handling implement.

FIG. 3 is a representative perspective view of the FIG. 2 adapter with a tooth mounted to a lip of the material handling implement.

FIG. 4 is a representative exploded perspective view of another example of the adapter.

FIG. 5 is a representative perspective view of the FIG. 4 adapter and the lip of the material handling implement.

FIG. 6 is a representative perspective and cross-sectional view of an insert of the FIG. 4 adapter.

FIG. 7 is a representative perspective view of the FIG. 4 adapter being mounted to the lip of the material handling implement.

FIG. 8 is a representative perspective view of the FIG. 4 adapter mounted to the lip.

FIG. 9 is a representative exploded perspective view of an example of a wear cap being attached to the adapter.

FIG. 10 is a representative perspective view of the adapter with the wear cap and a tooth mounted to the lip.

FIG. 11 is a representative perspective cross-sectional view of an example interface between the adapter and a stabilizer attached to the lip.

FIG. 12 is a representative perspective cross-sectional view of the adapter with the wear cap and the tooth mounted to the lip.

FIG. 13 is a representative exploded perspective view of another example of the adapter.

FIG. 14 is a representative perspective view of the partially assembled FIG. 13 adapter.

FIG. 15 is a representative perspective view of the assembled FIG. 13 adapter.

FIG. 16 is a representative perspective view of another example of the adapter being mounted to the lip.

FIG. 17 is a representative cross-sectional view of the FIG. 16 adapter positioned on the lip.

FIG. 18 is a representative top view of another example of the adapter.

FIG. 19 is a representative side view of the FIG. 18 adapter.

### DETAILED DESCRIPTION

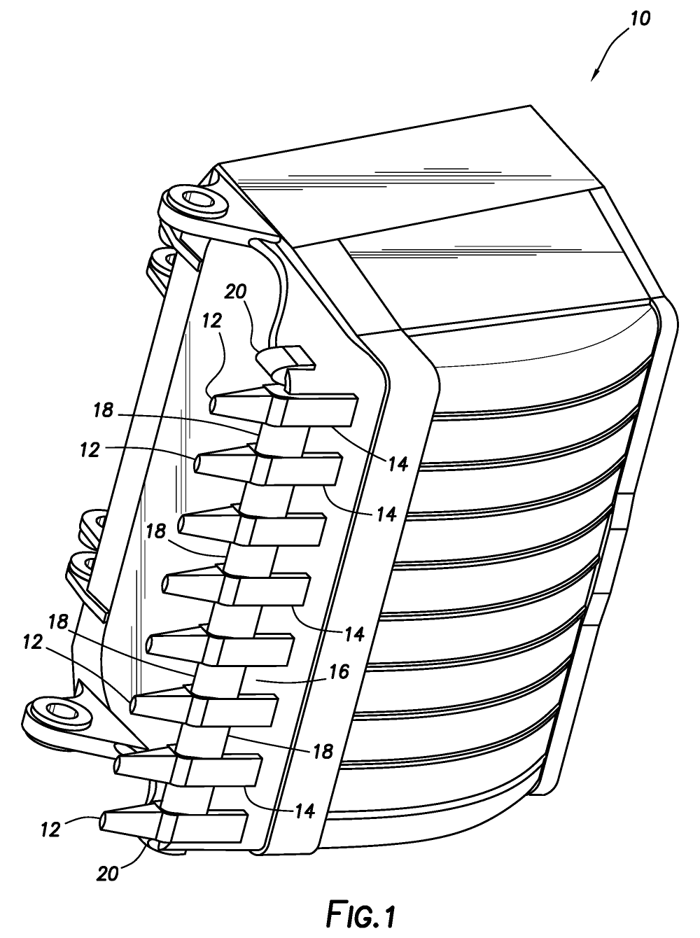

Representatively illustrated in FIG. 1 is an implement 10 for a material handling apparatus which can embody principles of this disclosure. However, it should be clearly understood that the implement 10 is merely one example of an application of the principles of this disclosure in practice, and a wide variety of other examples are possible. Therefore, the scope of this disclosure is not limited at all to the details of the implement 10 described herein and/or depicted in the drawings.

In the example of FIG. 1, the implement 10 is of the type known as a “dipper” or “bucket” of a cable shovel, but it should be clearly understood that the principles of this disclosure can be utilized with other types of mining, excavation (or other material handling) implements. In the illustration of FIG. 1, the implement 10 is rotated so that a bottom material-engaging side of the implement is clearly visible. From this perspective, it may be seen that multiple teeth 12 are mounted on the implement 10 for piercing the earth or other material.

The teeth 12 are typically rapidly worn down or otherwise damaged during use of the implement 10, and so the teeth are replaced periodically or when excessive wear is evident. Specially configured adapters 14 releasably secure the teeth 12 to a forward edge of a lip 16 of the implement 10 in this example. Shrouds 18, 20 protect forward material-engaging edges of the lip 16 and sides of the implement 10.

The teeth 12 are examples of wear components that can be securely and conveniently attached to a material handling implement using the principles of this disclosure. However, the scope of this disclosure is not limited to use of any particular types of wear components.

As used herein, the term “forward” is used to indicate a direction in which the implement 10 displaces to engage a material. Thus, a forward edge of the lip 16 would first engage the material, if the forward edge were not protected by the teeth 12, adapter 14 and shrouds 18, 20. The term “rearward” is used to indicate an opposite direction. Thus, in the FIG. 1 example, a rearward direction would be toward a back of the implement 10 from the forward edge of the lip 16.

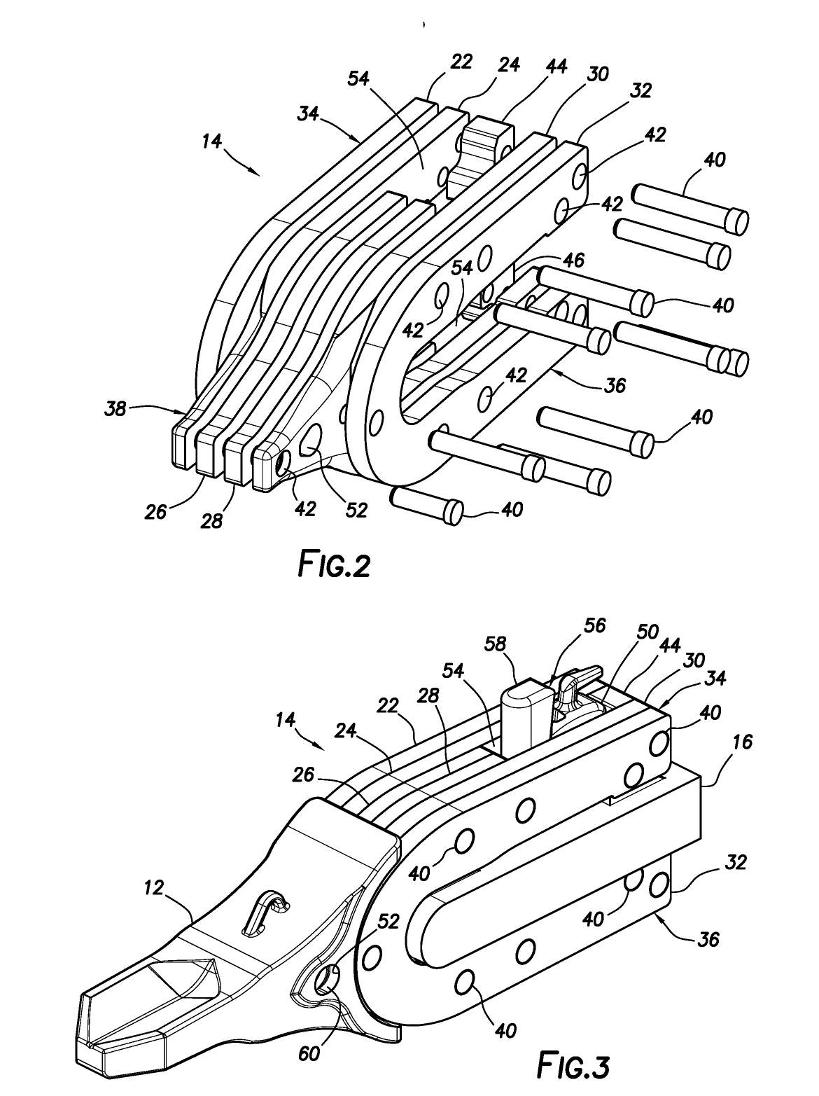

Referring additionally now to FIG. 2, a representative exploded perspective view of an example of the adapter 14 is depicted. The FIG. 2 adapter 14 is described below as it may be used with the FIG. 1 material handling implement 10, but in other examples the adapter may be used with other types of material handling implements.

In the FIG. 2 example, the adapter 14 is made up of multiple connected together laminations or layers 22, 24, 26, 28, 30, 32. When connected together, the layers 22, 24, 26, 28, 30, 32 form upper and lower legs 34, 36 and a wear component connector 38 of the adapter 14. The legs 34, 36 extend rearward from the connector 38 and are designed to engage upper and lower sides of the lip 16.

As depicted in FIG. 2, the layers 22, 24, 26, 28, 30, 32 are oriented so that they will be generally orthogonal to the lip 16 when the adapter 14 is mounted on the lip. The layers 22, 24, 26, 28, 30, 32 are connected together in this example with weld pins 40 installed in respective aligned holes 42. In other examples, other types of fasteners or connecting means (such as, rivets, threaded fasteners, etc.) may be used to connect the layers 22, 24, 26, 28, 30, 32.

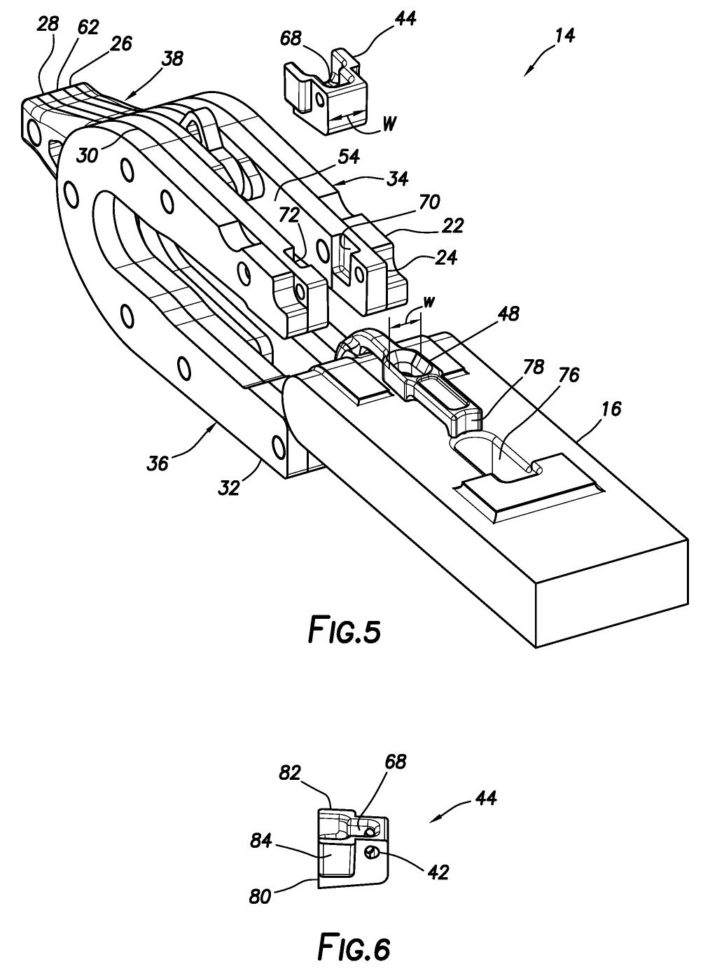

In the FIG. 2 example, inserts 44, 46 are positioned between the layers 24, 30 at rearward ends of the respective upper and lower legs 34, 36. The inserts 44, 46 each have a lateral width equal to the sum of the lateral widths of the layers 26, 28. This spacing maintains the layers 22, 24, 30, 32 generally parallel to each other. As described more fully below, the lateral width W of the inserts 44, 46 can correspond to a width w of a lateral stabilizer 48 (e.g., see FIG. 5) on the lip 16.

The inserts 44, 46 in this example are shaped to engage opposite ends of a clamp 50 (e.g., see FIG. 3) received in the adapter 14 between the layers 24, 30. The inserts 44, 46 can be connected between the layers 24, 30 and secured therein using the pins 40 or other fasteners, before or after the adapter 14 is positioned on the lip 16. As described more fully below, connecting the inserts 44, 46 between the layers 24, 30 after positioning the adapter 14 on the lip 16 can permit the lateral stabilizer 48 to be received in the adapter without interference with the inserts.

In the FIG. 2 example, the outer layers 22, 32 each comprises vertical sections of the upper and lower legs 34, 36 and a rearward section of the connector 38. Each of the layers 24, 26, 28, 30 extends further forward from the outer layers 22, 32 to form a nose of the connector 38 used to attach a wear component (such as, a tooth 12) to the adapter 14. Aligned fastener receiving openings 52 formed in the layers 24, 26, 28, 30 receive a suitable fastener therein to secure the wear component to the connector 38.

Each of the layers 24, 26, 28, 30 extends rearward to form respective vertical sections of the legs 34, 36. The inner layers 26, 28 do not extend rearward as far as the layers 24, 30, thereby forming clamp receiving openings 54 laterally between the layers 24, 30 and forward of the respective insert 44, 46.

Referring additionally now to FIG. 3, a representative perspective view of the FIG. 2 adapter 14 with a tooth 12 mounted to the lip 16 is depicted. The layers 22, 24, 26, 28, 30, 32 are connected together to form the assembled adapter 14. The tooth 12 is secured to the nose of the connector 38 using a suitable fastener 60 installed in the aligned openings 52.

A clamp assembly 56 is received in the openings 54. In this example, the clamp assembly 56 includes the clamp 50 and a displaceable wedge 58 for securing the adapter 14 to the lip 16.

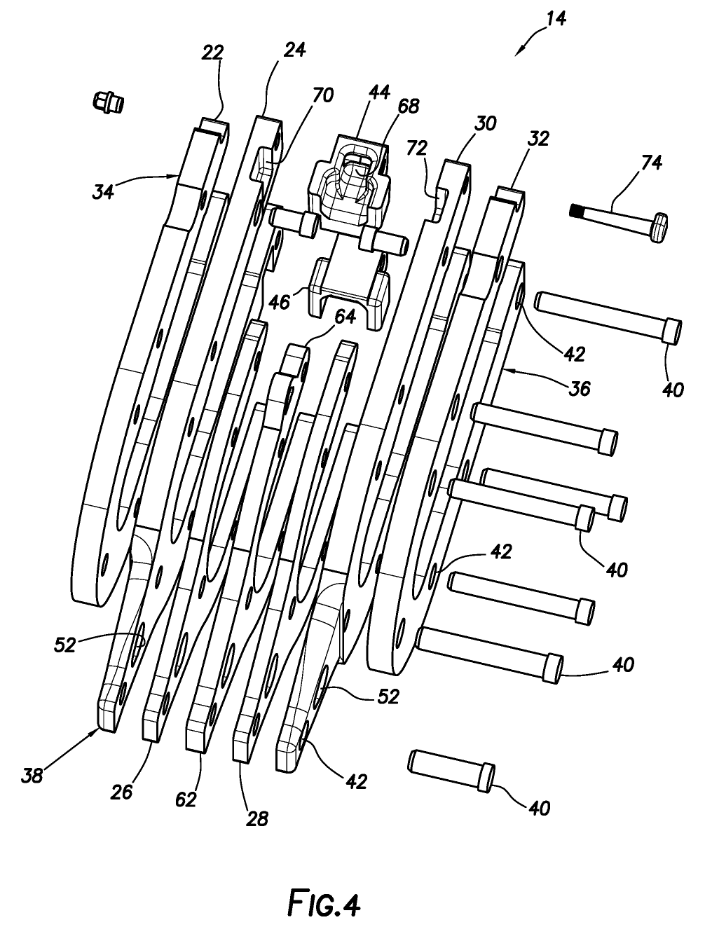

Referring additionally now to FIG. 4, a representative exploded perspective view of another example of the adapter 14 is depicted. In this example, an additional layer 62 is positioned between the inner layers 26, 28. The layer 62 is shaped similar to the inner layers 26, 28, but the layer 62 includes profiles 64 shaped to engage wear caps 66 (e.g., see FIG. 9) to secure the wear caps on the upper and lower legs 34, 36. In some examples, only one wear cap 66 may be used.

The FIG. 4 inserts 44, 46 are shaped somewhat different from the FIGS. 2 & 3 inserts. The FIG. 4 inserts 44, 46 include internal profiles 68 shaped to engage the wear caps 66 to secure them on the upper and lower legs 34, 36. The layers 24, 30 have recesses 70, 72 formed therein to receive the respective inserts 44, 46.

In the FIG. 4 example, the insert 44 is connected between the layers 24, 30 by use of a threaded fastener 74. This enables the insert 44 to be conveniently installed after the adapter 14 has been positioned on the lip 16. However, in other examples the insert 44 can be installed and secured with the fasteners 74, the pins 40, or other connecting means, before the adapter 14 is positioned on the lip 16. In some examples, both of the inserts 44, 46 can be connected between the layers 24, 30 after the adapter 14 is positioned on the lip 16.

Referring additionally now to FIG. 5, a representative perspective view of the FIG. 4 adapter 14 and the lip 16 is depicted. In this example, the lateral stabilizer 48 is positioned on the lip 16 forward of a clamp receiving opening 76 formed through the lip.

Note that, with the insert 44 not yet installed between the layers 24, 30, the lateral stabilizer 48 can pass laterally between the layers 24, 30. In addition, there is no height restriction on the stabilizer 48 posed by the insert 44 as the adapter 14 is displaced rearward onto the lip 16 and the stabilizer displaces forward between the layers 24, 30. In this example, a lateral width W of the insert 44 used to space apart the layers 24, 30 is somewhat greater than a maximum lateral width w of the stabilizer 48.

The stabilizer 48 includes a rearward facing surface 78 that is engaged by the clamp wedge 58 (see FIG. 3) when the adapter 14 is secured onto the lip 16. Another benefit of having the capability to install the insert 44 after the adapter 14 has been positioned on the lip 16 is that a distance between the lip 16 and a surface 80 (see FIG. 6) on the insert 44 that engages the clamp 50 can be reduced, thereby reducing movement of the upper leg 34 due to digging loads applied to the wear component and adapter. In this example, the contact between the clamp 50 and the surface 80 is closer to the lip 16 than the contact between the wedge 58 and the surface 78.

Referring additionally now to FIG. 6, a representative perspective and cross-sectional view of the insert 44 of the FIG. 4 adapter 14 is depicted. In this view it may be seen that the forward facing surface 80 extends downward (toward the lip 16 when installed) from projections 82, 84 extending laterally from the insert 44. The projections 82, 84 are configured to cooperatively engage the respective recesses 70, 72.

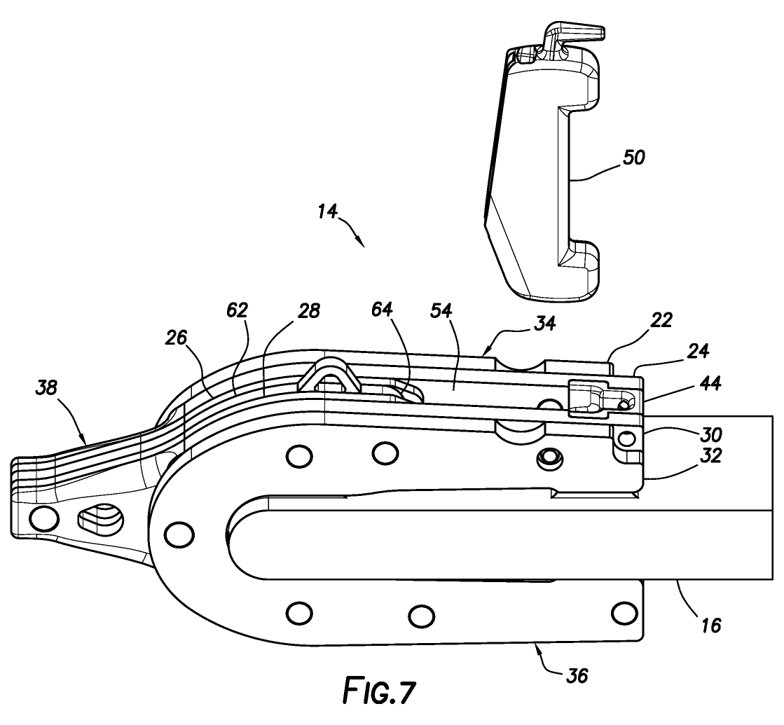

Referring additionally now to FIG. 7, a representative perspective view of the FIG. 4 adapter 14 being mounted to the lip 16 is depicted. The adapter 14 is positioned on the lip 16 (for example, by sliding the adapter rearward onto the lip, so that the lip is received between the legs 34, 36). The insert 44 is then connected between the layers 24, 30 (for example, using the threaded fastener 74). In other examples, the insert 44 may be connected between the layers 24, 30 before the adapter 14 is positioned on the lip 16.

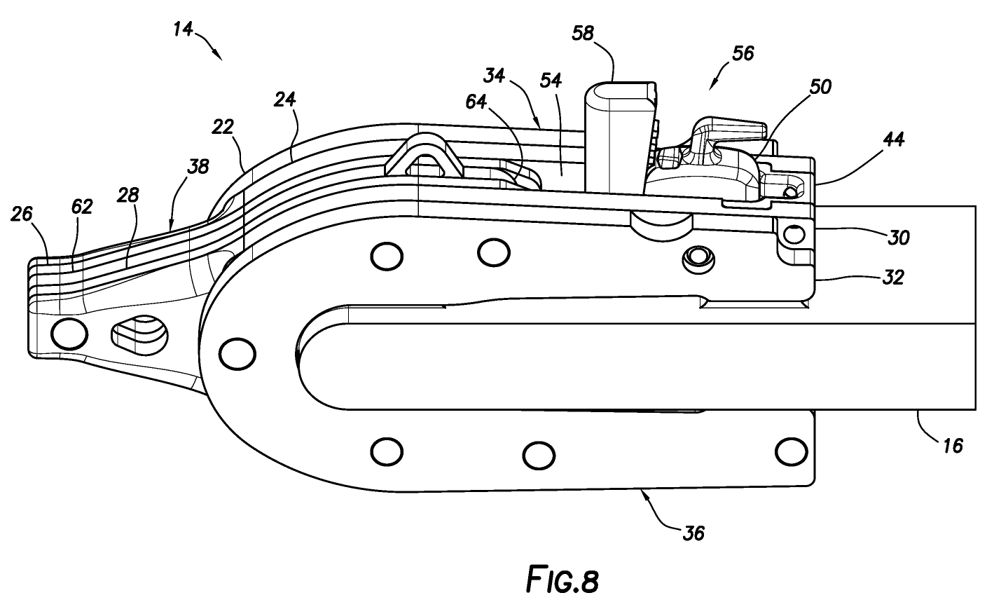

The clamp 50 is installed in the opening 54 after the inserts 44, 46 are connected in the adapter 14. The wedge 58 (see FIG. 8) is then installed in the opening 54 and tightened to secure the adapter 14 to the lip 16.

Referring additionally now to FIG. 8 a representative perspective view of the FIG. 4 adapter 14 mounted to the lip 16 is depicted. The adapter 14 has been appropriately positioned on the lip 16, the inserts 44, 46 have been connected or positioned between the layers 24, 30, and the clamp assembly 56 has been installed in the opening 54 to secure the adapter to the lip. Opposite ends of the clamp 50 engage the profiles 68 in the inserts 44, 46, and the wedge 58 has been tightened, thereby biasing the wedge against the stabilizer surface 78 (see FIG. 5) and biasing the clamp 50 against the surfaces 80 on the inserts 44, 46 (see FIG. 6).

Referring additionally now to FIG. 9, a representative exploded perspective view of an example of the wear cap 66 being attached to the adapter 14 is depicted. In this example, the wear cap 66 includes projections 86, 88 that extend respectively forward and rearward.

The projection 86 engages the profile 64 formed on the layer 62 to secure a forward end of the wear cap 66. The projection 88 is received in the recess 68 formed in the insert 44 to secure a rearward end of the wear cap 66 when the fastener 74 is installed. Projections 90 extending downward from opposite lateral sides of the wear cap 66 will engage recesses 92 formed in the outer layers 22, 32.

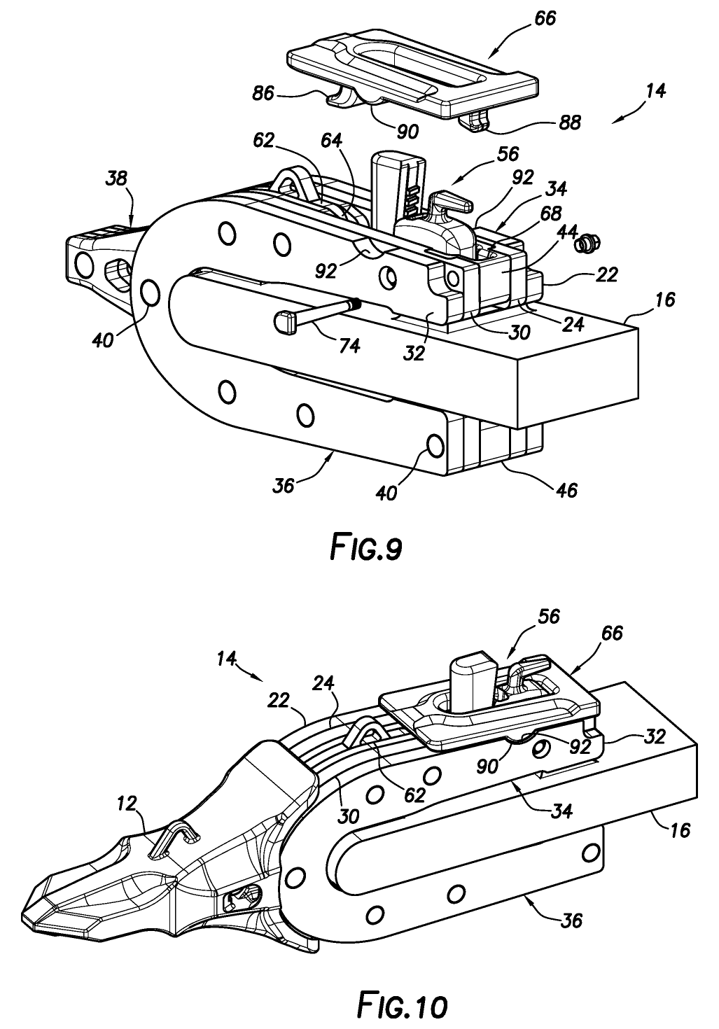

Referring additionally now to FIG. 10, a representative perspective view of the adapter 14 with the wear cap 66 and a tooth 12 mounted to the lip 16 is depicted. In this view, the adapter 14 is fully assembled with the tooth 12 and wear cap 66. In some examples no wear cap may be used, or a wear cap may be used on both of the legs 34, 36.

Referring additionally now to FIG. 11, a representative perspective cross-sectional view of an example interface between the adapter 14 and the stabilizer 48 attached to the lip 16 is depicted. In this view it may be seen that opposite lateral sides of the stabilizer 48 engage respective lateral sides of the layers 24, 30. The combined widths of the layers 26, 28, 62 are at least as large as the width w of the stabilizer 48 (see FIG. 5), so the stabilizer can fit laterally between the layers 24, 30. The contact between the layers 24, 30 and the opposite sides of the stabilizer 48 resists lateral movement of the adapter 14 on the lip 16 due to loads applied to the tooth 12.

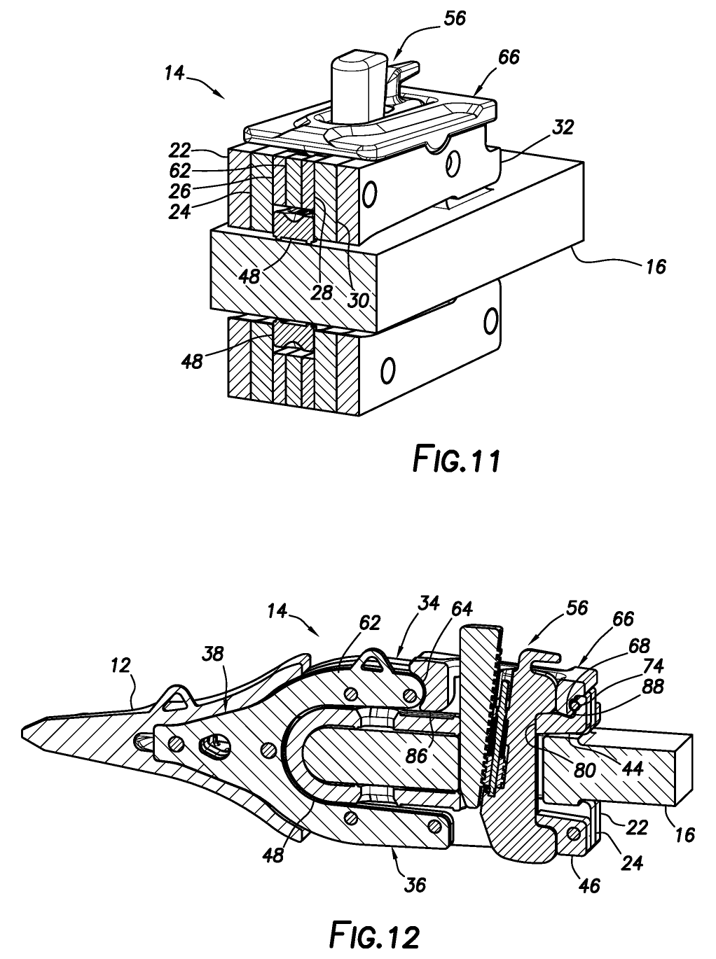

Referring additionally now to FIG. 12, a representative perspective cross-sectional view of the adapter 14 with the wear cap 66 and the tooth 12 mounted to the lip 16 is depicted. In this view, the manner in which the projections 86, 88 engage the profile 64 on the layer 62 and the profile 68 in the insert 44 can be seen.

Referring additionally now to FIG. 13, a representative exploded perspective view of another example of the adapter 14 is depicted. The FIG. 13 example is similar in many respects to the FIGS. 2 & 3 example. However, in the FIG. 13 example, each of the layers comprises two sections, with one section of each layer (e.g., layer sections 22b, 24b, 26b, 28b, 30b, 32b) being pivotable or rotatable relative to the other section (e.g., layer sections 22a, 24a, 26a, 28a, 30a, 32a).

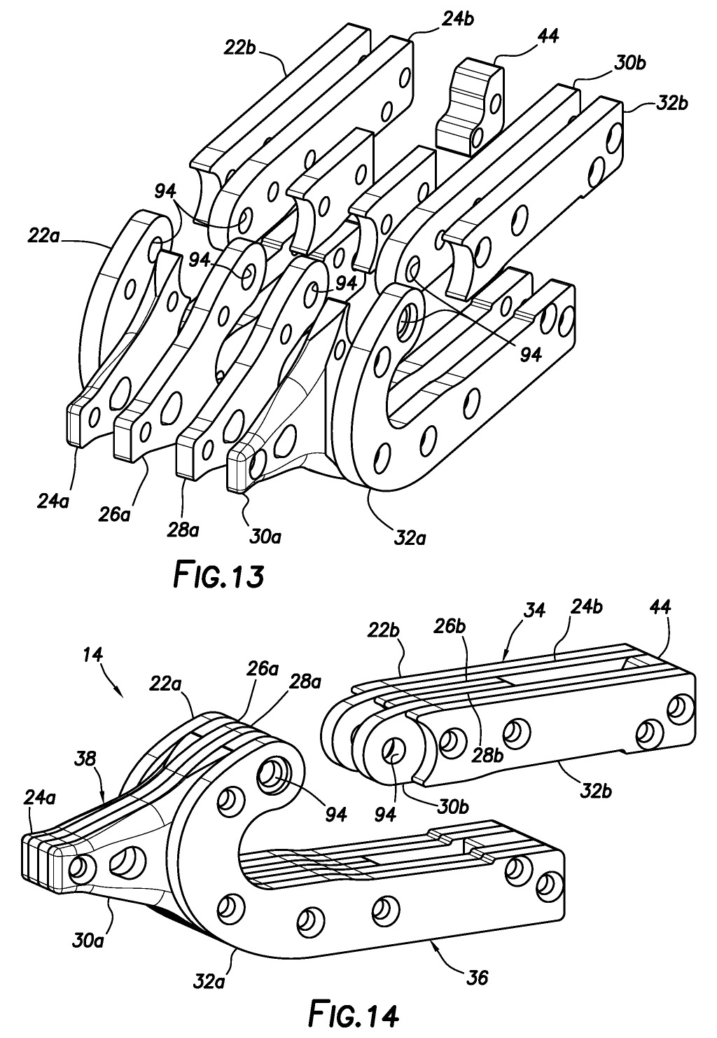

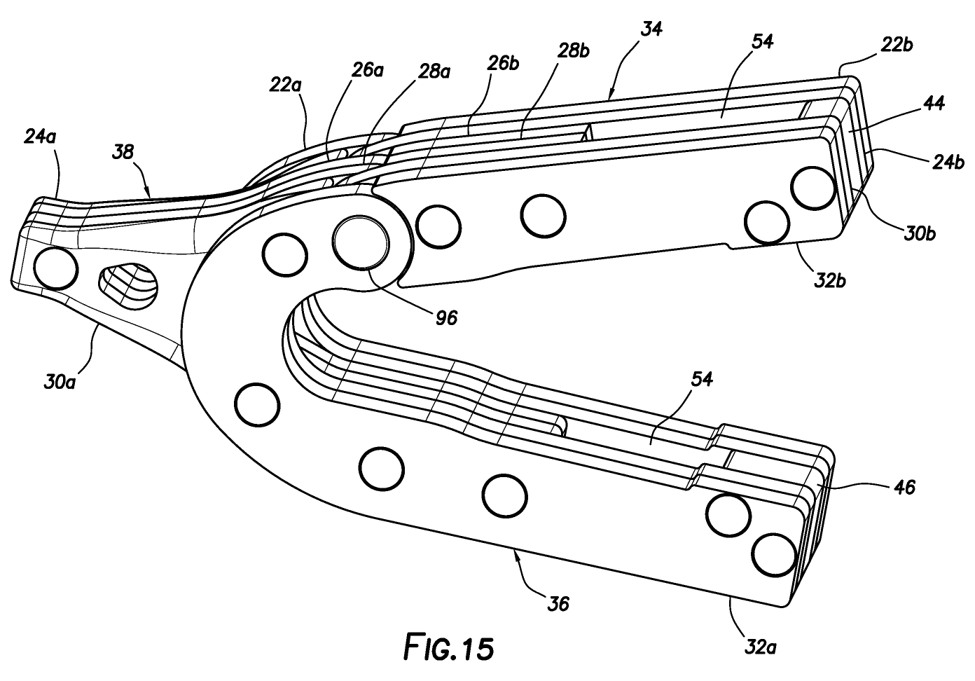

Referring additionally now to FIG. 14, a representative perspective view of the partially assembled FIG. 13 adapter 14 is depicted. In this view, the layer sections 22a, 24a, 26a, 28a, 30a, 32a are combined to form the lower leg 36 and the connector 38. The layer sections 22b, 24b, 26b, 28b, 30b, 32b are combined to form the upper leg 34. Openings 94 are provided in the layer sections 22a, 26a, 28a, 32a, 24b, 30b for a pivot pin 96 (see FIG. 15) to provide for rotation of the upper leg 34 relative to the lower leg 36 and connector 38.

Referring additionally now to FIG. 15, a representative perspective view of the assembled FIG. 13 adapter 14 is depicted. In this view it may be seen that the upper leg 34 is rotatable about the pivot pin 96 relative to the lower leg 36 and the connector 38.

This rotation of the upper leg 34 can assist with mounting the adapter 14 on the lip 16. For example, if the height of a lateral stabilizer 48 on the lip 16 is greater than a distance between the insert 44 (or insert 46) and the lip when the adapter 14 is fully mounted on the lip, pivoting of the upper leg 34 away from the lip can enable the insert 44 to be displaced past the stabilizer, and then the upper leg 34 is rotated into contact with the surface of the lip and the clamp assembly 56 is installed to secure the adapter to the lip.

In other examples, an adapter similar to the FIGS. 4-12 adapter 14 can be provided with a leg 36 that rotates relative to the leg 34 and the connector 38. Either or both of the legs 34, 36 can be rotatable relative to the connector 38 in any of the adapter 14 examples disclosed herein.

Referring additionally now to FIG. 16, a representative perspective view of another example of the adapter 14 being mounted to the lip 16 is depicted. In this example, both of the legs 34, 36 are rotatable relative to the connector 38. Rotation of the legs 34, 36 allows the adapter 14 to be appropriately positioned on the lip 16, even though the inserts 44, 46 are very close to the lip 16 when the adapter is eventually secured to the lip.

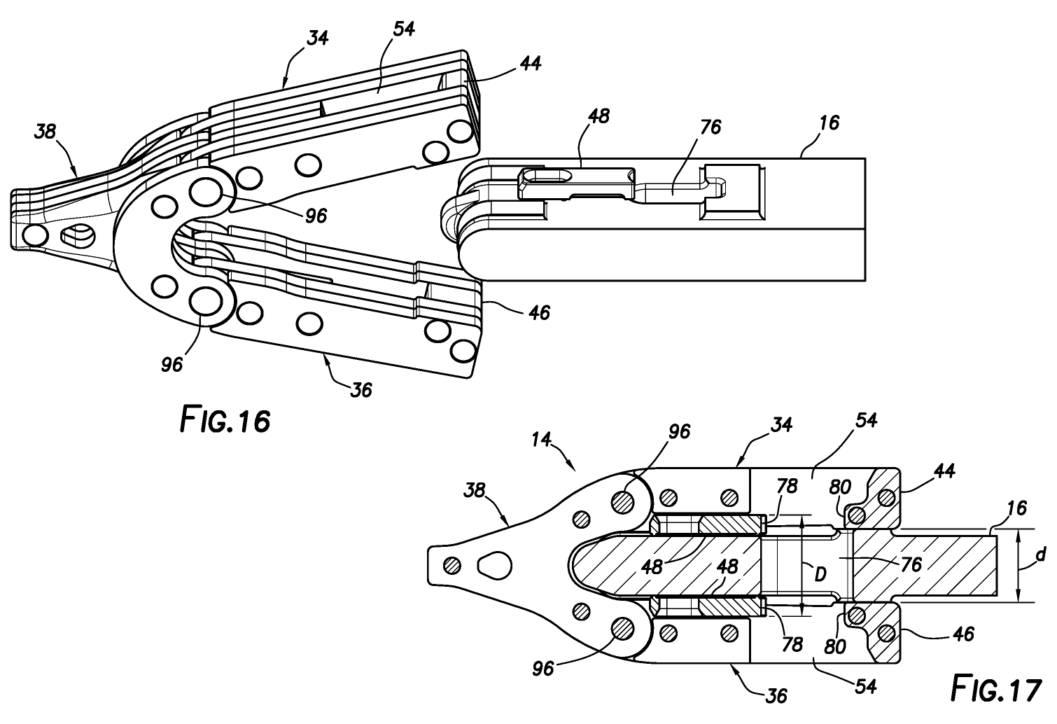

Referring additionally now FIG. 17, a representative cross-sectional view of the FIG. 16 adapter 14 positioned on the lip 16 is depicted. To secure the adapter 14 to the lip 16, the clamp assembly 56 will be installed in the openings 54, 76 and the wedge 58 will be tightened.

In the FIG. 17 example, a minimum distance d between the inserts 44, 46 is less than a maximum distance D between outer surfaces of the lateral stabilizers 48. Thus, the inserts 44, 46 would not have been able to pass over the stabilizers 48 when the adapter 14 was positioned on the lip 16, without rotating the legs 34, 36 away from the lip.

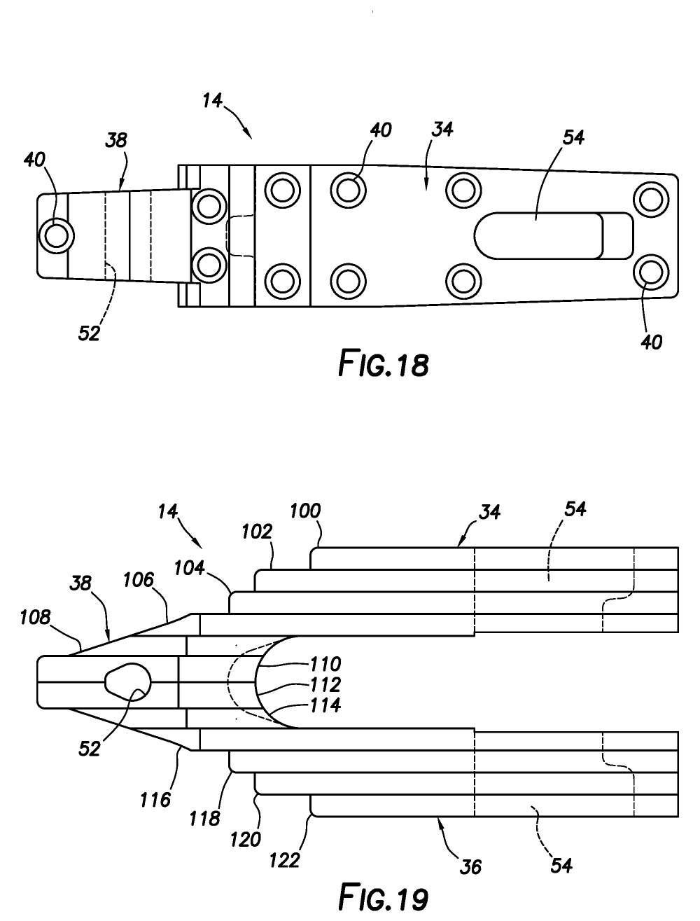

Referring additionally now to FIGS. 18 & 19, representative top and side views of another example of the adapter 14 are depicted. In this example, laminations or layers 100, 102, 104, 106, 108, 110, 112, 114, 116, 118, 120, 122 of the adapter 14 are oriented orthogonal to the layers 22, 24, 26, 28, 30, 32, 62 of the FIGS. 2-17 examples. When the FIGS. 18 & 19 adapter 14 is mounted to the lip 16, the layers 100, 102, 104, 106, 108, 110, 112, 114, 116, 118, 120, 122 are oriented parallel to the lip.

Note that some of the layers 100, 102, 120, 122 form respective sections of either the upper leg 34 or the lower leg 36. Other layers 104, 106, 116, 118 form respective sections of the connector 38 and either of the legs 34, 36. Certain layers 108, 110, 112, 114 may be considered to comprise respective sections of the connector 38.

Although separate inserts 44, 46 are not depicted in the FIGS. 18 & 19 example, separate inserts may be used if desired (for example, to allow the adapter 14 to slide over a stabilizer 48 attached to the lip 16). The FIGS. 18 & 19 adapter 14 may be provided with one or both of the legs 34, 36 being rotatable relative to the connector 38 (such as, in the FIGS. 13-17 examples).

Any of the layers 22, 24, 26, 28, 30, 32, 62, 100, 102, 104, 106, 108, 110, 112, 114, 116, 118, 120, 122 in any of the examples described herein may be in the form of a flat planar lamination comprising a tough, strong and abrasion resistant material (such as, a steel alloy, a tungsten alloy, etc.). The laminations or layers may be formed using any suitable fabrication technique (for example, machining, three-dimensional printing, casting, hot or cold rolling, etc.).

It may now be fully appreciated that the above disclosure provides significant benefits to the art of designing, constructing and using adapters for material handling implements. In examples described above, the adapter 14 can be constructed in a manner that improves the strength and durability of the adapter. In some examples, the adapter 14 is constructed from multiple separate connected together laminations or layers 22, 24, 26, 28, 30, 32, 62, 100, 102, 104, 106, 108, 110, 112, 114, 116, 118, 120, 122. In some examples, one or both legs 34, 36 of the adapter 14 is/are rotatable relative to the connector 38 or to the other leg.

This disclosure provides to the art an adapter 14 for connecting a wear component (such as, the tooth 12) to a lip 16 of a material handling implement 10. In one example, the adapter 14 comprises: a connector 38 configured to releasably secure the wear component 12 to the adapter 14; first and second legs 34, 36 extending rearward relative to the connector 38 and configured to straddle the lip 16; and at least one of the connector 38 and the first and second legs 34, 36 comprising multiple separate layers 22, 24, 26, 28, 30, 32, 62, 100, 102, 104, 106, 108, 110, 112, 114, 116, 118, 120, 122.

In some examples, both of the first and second legs 34, 36 are made up of the multiple separate layers 22, 24, 26, 28, 30, 32, 62, 100, 102, 104, 106, 108, 110, 112, 114, 116, 118, 120, 122. In some examples, the first leg 34 comprises a first one of the layers 100, 102, and the second leg 36 comprises a second one of the layers 120, 122.

The layers 22, 24, 26, 28, 30, 32, 62, 100, 102, 104, 106, 108, 110, 112, 114, 116, 118, 120, 122 may comprise laminations. All of the connector 38 and the first and second legs 34, 36 may comprise the layers 22, 24, 26, 28, 30, 32, 62, 100, 102, 104, 106, 108, 110, 112, 114, 116, 118, 120, 122.

At least one of the first and second legs 34, 36 may be rotatable relative to the connector 38. Both of the first and second legs 34, 36 may be rotatable relative to the connector 38.

The adapter 14 may include an insert 44, 46 secured between first and second layers 24, 30, 24b, 30b. The insert 44, 46 may be configured to engage a clamp 50 received in the adapter 14. The insert 44, 46 may be configured to secure a wear cap 66 on one of the first and second legs 34, 36.

First and second layers 24, 30, 24b, 30b of the adapter 14 may be configured to laterally straddle a lateral stabilizer 48 attached to the lip 16. The adapter 14 can also include an insert 44, 46 secured between the first and second layers 24, 30, 24b, 30b. The insert 44, 46 may be configured to engage a clamp 50 received in the adapter 14, and a lateral width W of the insert 44, 46 may be at least as great as a lateral width w of the lateral stabilizer 48.

Each of the first and second layers 106, 116 may be oriented parallel to the lip 16 when the adapter 14 is mounted on the lip 16. Each of the first and second layers 24, 30, 24b, 30b may be oriented orthogonal to the lip 16 when the adapter 14 is mounted on the lip 16.

Also disclosed is an adapter 14 comprising: a connector 38 configured to releasably secure a wear component 12 to the adapter 14; first and second legs 34, 36 extending rearward relative to the connector 38 and configured to straddle the lip 16. At least one of the first and second legs 34, 36 is rotatable relative to the connector 38. In some examples, both of the first and second legs 34, 36 are rotatable relative to the connector 38.

A method of mounting an adapter 14 on a lip 16 of a material handling implement 10 is also provided to the art by this disclosure. In one example, the method can include: connecting together multiple separate layers 22, 24, 26, 28, 30, 32, 62, 100, 102, 104, 106, 108, 110, 112, 114, 116, 118, 120, 122 of the adapter 14, the connected layers 22, 24, 26, 28, 30, 32, 62, 100, 102, 104, 106, 108, 110, 112, 114, 116, 118, 120, 122 comprising a wear component connector 38 and first and second legs 34, 36 extending rearward relative to the connector 38; positioning the adapter 14 on the lip 16; securing the adapter 14 to the lip 16; and attaching a wear component 12 to the wear component connector 38.

The method may include securing an insert 44, 46 between first and second ones of the layers 24, 30, the insert 44, 46 being configured to engage a clamp 50 received in the adapter 14. The insert securing step may be performed after the positioning step. The insert 44, 46 may secure a wear cap 66 on one of the first and second legs 34, 36. The positioning step may include the first and second layers 24, 30 laterally straddling a lateral stabilizer 48 attached to the lip 16. A lateral width W of the insert 44, 46 may be at least as great as a lateral width w of the lateral stabilizer 48.

The positioning step may include rotating at least one of the legs 34, 36 relative to the wear component connector 38. The positioning step may include rotating both of the legs 34, 36 relative to the wear component connector 38.

In the positioning step, the layers 22, 24, 26, 28, 30, 32, 62 may be oriented orthogonal to the lip 16. In other examples, the layers 100, 102, 104, 106, 108, 110, 112, 114, 116, 118, 120, 122 may be oriented parallel to the lip 16.

The connecting step may include forming at least one of the connector 38 and the first and second legs 34, 36 from the multiple separate layers 22, 24, 26, 28, 30, 32, 62, 100, 102, 104, 106, 108, 110, 112, 114, 116, 118, 120, 122. The connecting step may include forming both of the first and second legs 34, 36 from the multiple separate layers 22, 24, 26, 28, 30, 32, 62. The connecting step may include forming the first leg 34 with a first one of the layers 100, 102, and forming the second leg 36 with a second one of the layers 120, 122.

Another disclosed method of mounting an adapter 14 on a lip 16 of a material handling implement 10 can comprise: positioning the adapter 14 on the lip 16, the adapter 14 comprising a wear component connector 38 and first and second legs 34, 36 extending rearward relative to the connector 38, the positioning comprising rotating at least one of the legs 34, 36 relative to the wear component connector 38; securing the adapter 14 to the lip 16; and attaching a wear component 12 to the wear component connector 38.

Although various examples have been described above, with each example having certain features, it should be understood that it is not necessary for a particular feature of one example to be used exclusively with that example. Instead, any of the features described above and/or depicted in the drawings can be combined with any of the examples, in addition to or in substitution for any of the other features of those examples. One example’s features are not mutually exclusive to another example’s features. Instead, the scope of this disclosure encompasses any combination of any of the features.

Although each example described above includes a certain combination of features, it should be understood that it is not necessary for all features of an example to be used. Instead, any of the features described above can be used, without any other particular feature or features also being used.

It should be understood that the various embodiments described herein may be utilized in various orientations, such as inclined, inverted, horizontal, vertical, etc., and in various configurations, without departing from the principles of this disclosure. The embodiments are described merely as examples of useful applications of the principles of the disclosure, which is not limited to any specific details of these embodiments.

In the above description of the representative examples, directional terms (such as “above,” “below,” “upper,” “lower,” “upward,” “downward,” etc.) are used for convenience in referring to the accompanying drawings. However, it should be clearly understood that the scope of this disclosure is not limited to any particular directions described herein.

The terms “including,” “includes,” “comprising,” “comprises,” and similar terms are used in a non-limiting sense in this specification. For example, if a system, method, apparatus, device, etc., is described as “including” a certain feature or element, the system, method, apparatus, device, etc., can include that feature or element, and can also include other features or elements. Similarly, the term “comprises” is considered to mean “comprises, but is not limited to.”

Of course, a person skilled in the art would, upon a careful consideration of the above description of representative embodiments of the disclosure, readily appreciate that many modifications, additions, substitutions, deletions, and other changes may be made to the specific embodiments, and such changes are contemplated by the principles of this disclosure. For example, structures disclosed as being separately formed can, in other examples, be integrally formed and vice versa. Accordingly, the foregoing detailed description is to be clearly understood as being given by way of illustration and example only, the spirit and scope of the invention being limited solely by the appended claims and their equivalents.

What is claimed is:

1. An adapter for connecting a wear component to a lip of a material handling implement, the adapter comprising:
a connector configured to releasably secure the wear component to the adapter;
first and second legs extending rearward relative to the connector and configured to straddle the lip; and
at least one of the connector and the first and second legs comprising multiple separate layers.

2. The adapter of claim 1, in which both of the first and second legs are made up of the multiple separate layers.

3. The adapter of claim 1, in which the first leg comprises a first one of the layers, and the second leg comprises a second one of the layers.

4. The adapter of claim 1, in which the layers comprise laminations.

5. The adapter of claim 1, in which all of the connector and the first and second legs comprise the layers.

6. The adapter of claim 1, in which at least one of the first and second legs is rotatable relative to the connector.

7. The adapter of claim 1, in which both of the first and second legs is rotatable relative to the connector.

8. The adapter of claim 1, further comprising an insert secured between first and second layers, in which the insert is configured to engage a clamp received in the adapter.

9. The adapter of claim 1, further comprising an insert secured between first and second layers, in which the insert is configured to secure a wear cap on one of the first and second legs.

10. The adapter of claim 1, in which first and second layers are configured to laterally straddle a lateral stabilizer attached to the lip.

11. The adapter of claim 10, further comprising an insert secured between the first and second layers, in which the insert is configured to engage a clamp received in the adapter, and a lateral width of the insert is at least as great as a lateral width of the lateral stabilizer.

12. The adapter of claim 1, in which each of the first and second layers is configured to be oriented parallel to the lip when the adapter is mounted on the lip.

13. The adapter of claim 1, in which each of the first and second layers is configured to be oriented orthogonal to the lip when the adapter is mounted on the lip.

14. An adapter for connecting a wear component to a lip of a material handling implement, the adapter comprising:
a connector configured to releasably secure the wear component to the adapter;
first and second legs extending rearward relative to the connector and configured to straddle the lip; and
in which at least one of the first and second legs is rotatable relative to the connector.

15. The adapter of claim 14, in which both of the first and second legs are rotatable relative to the connector.

16. The adapter of claim 14, in which at least one of the connector and the first and second legs comprises multiple separate layers.

17. The adapter of claim 16, in which both of the first and second legs are made up of the multiple separate layers.

18. The adapter of claim 16, in which the first leg comprises a first one of the layers, and the second leg comprises a second one of the layers.

19. The adapter of claim 16, in which the layers comprise laminations.

20. The adapter of claim 16, in which all of the connector and the first and second legs comprise the layers.

21. The adapter of claim 16, further comprising an insert secured between first and second layers, in which the insert is configured to engage a clamp received in the adapter.

22. The adapter of claim 16, further comprising an insert secured between first and second layers, in which the insert is configured to secure a wear cap on one of the first and second legs.

23. The adapter of claim 16, in which first and second layers are configured to laterally straddle a lateral stabilizer attached to the lip.

24. The adapter of claim 23, further comprising an insert secured between the first and second layers, in which the insert is configured to engage a clamp received in the adapter, and a lateral width of the insert is at least as great as a lateral width of the lateral stabilizer.

25. The adapter of claim 16, in which each of the first and second layers is configured to be oriented parallel to the lip when the adapter is mounted on the lip.

26. The adapter of claim 16, in which each of the first and second layers is configured to be oriented orthogonal to the lip when the adapter is mounted on the lip.

27. A method of mounting an adapter on a lip of a material handling implement, the method comprising:
connecting together multiple separate layers of the adapter, the connected layers comprising a wear component connector and first and second legs extending rearward relative to the connector;
positioning the adapter on the lip;
securing the adapter to the lip; and
attaching a wear component to the wear component connector.

28. The method of claim 27, further comprising securing an insert between first and second ones of the layers, the insert being configured to engage a clamp received in the adapter.

29. The method of claim 28, in which the insert securing is performed after the positioning.

30. The method of claim 27, further comprising securing an insert between first and second ones of the layers, the insert being configured to secure a wear cap on one of the first and second legs.

31. The method of claim 30, in which the positioning comprises the first and second layers laterally straddling a lateral stabilizer attached to the lip.

32. The method of claim 31, in which a lateral width of the insert is at least as great as a lateral width of the lateral stabilizer.

33. The method of claim 27, in which the positioning comprises rotating at least one of the legs relative to the wear component connector.

34. The method of claim 27, in which the positioning comprises rotating both of the legs relative to the wear component connector.

35. The method of claim 27, in which in the positioning, the layers are oriented orthogonal to the lip.

36. The method of claim 27, in which in the positioning, the layers are oriented parallel to the lip.

37. The method of claim 27, in which the connecting comprises forming at least one of the connector and the first and second legs from the multiple separate layers.

38. The method of claim 27, in which the connecting comprises forming both of the first and second legs from the multiple separate layers.

39. The method of claim 27, in which the connecting comprises forming the first leg with a first one of the layers, and forming the second leg with a second one of the layers.

40. A method of mounting an adapter on a lip of a material handling implement, the method comprising:
positioning the adapter on the lip, the adapter comprising a wear component connector and first and second legs extending rearward relative to the connector, the positioning comprising rotating at least one of the legs relative to the wear component connector;
securing the adapter to the lip; and
attaching a wear component to the wear component connector.

41. The method of claim 40, in which the positioning comprises rotating both of the legs relative to the wear component connector.

42. The method of claim 40, further comprising connecting together multiple separate layers of the adapter, the connected layers comprising;

43. The method of claim 42, further comprising securing an insert between first and second ones of the layers, the insert being configured to engage a clamp received in the adapter.

44. The method of claim 43, in which the insert securing is performed after the positioning.

45. The method of claim 42, further comprising securing an insert between first and second ones of the layers, the insert being configured to secure a wear cap on one of the first and second legs.

46. The method of claim 42, in which the positioning comprises the first and second layers laterally straddling a lateral stabilizer attached to the lip.

47. The method of claim 46, further comprising securing an insert between first and second ones of the layers, the insert being configured to engage a clamp received in the adapter, and a lateral width of the insert is at least as great as a lateral width of the lateral stabilizer.

48. The method of claim 42, in which in the positioning, the layers are oriented orthogonal to the lip.

49. The method of claim 42, in which in the positioning, the layers are oriented parallel to the lip.

50. The method of claim 42, in which the connecting comprises forming at least one of the connector and the first and second legs from the multiple separate layers.

51. The method of claim 42, in which the connecting comprises forming both of the first and second legs from the multiple separate layers.

52. The method of claim 42, in which the connecting comprises forming the first leg with a first one of the layers, and forming the second leg with a second one of the layers.
